(19) United States
(12) Patent Application Publication
(10) Pub. No.: US 2005/0035848 A1
(43) Pub. Date: Feb. 17, 2005

(54) Network directed embedded transceiver lock system and method

(76) Inventors: Majid Ali Syed, Princeton, NJ (US); Masoud Qurashi, Occean Twp., NJ (US)

Correspondence Address: MAJID ALI SYED, 97 YORK DRIVE, PRINCETON, NJ, 08540, US

(21) Appl. No.: 10/640,951

(22) Filed: Aug. 15, 2003

(51) Int. Cl. G08B 5/00; G06F 7/04

(52) U.S. Cl. 340/5.72; 379/102.06

(57) ABSTRACT

An addressable embedded transceiver lock (ETL) is proposed. The ETL is equipped with a network access interface (wired or wireless), subscriber serial data interface (wired or wireless), man machine interface and a command decoder. The network access interface is used to communicate with the remote service gateway the subscriber serial data interface is used to communicate with the subscriber home loop and a command decoder is used to take actions as constructed by the remote gateway. When ETL is powered, it first registers with the remote service gateway (a call center or owner of the unit) over a wide area network (wired or wireless). The service gateway maintains profile of the installed ETL and it's communicating capabilities. Upon demand by the remote attendant, the ETL performs operations such as lock open, lock close, lock status. ETL may also alert the service gateway of activities as predefined. Various derivatives of ETL may include Motion Sensor, Camera. GPS capture, Bluetooth and others with corresponding decoding stacks. One application of such device is in REAL-ESTATE use, where a remote broker office attendant may send commands to the ETL to open/close for a potential buyer standing outside a for sale property.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention is related to systems and methods for operating an embedded transceiver lock, which is, connected to a service gateway controller over any telecom infrastructure.

### 2 PRIOR ART

We find literature, which talk about hand held remote operation of the lock working over an ISM band, but none of these are networked, controlled and as such cannot be used for services as defined (as an example) in this disclosure. While, some issued patents 4777556, 4864115, 4851652, 4609780, 4800255, 5531086, 4594637, 4988987 and submitted applications #s 20010027669, 20010025517, 20020017121 and 20020130788 do provide special mechanism which allow to place physical metal keys of the real-estate property in a secured way, however, all these mechanism fail to address the followings:

1. Hand held remote control lock device (#20010027669, 5531086), not capable of performing network defined commands.

2. Remote controlled door lock system (#20020130788) discuss real-time confirmation of an armed or disarmed state of a door lock (of automobile) in an energy efficient manner regardless of surounding light conditions. It fails to address services as performed by ETL.

3. Electronic key need to be updated for certain time duration. It is well known in the art that two short and too long time duration is not suitable (#4988987).

4. If electronic key is lost, the place is vulnerable till the update expiry time is triggered (#49888987).

5. Unauthorize exchange of keys may occur (#4609780).

6. Service based lock operation is unavailable. For example, lock to be used by: for sale by owners, monitoring service, locked out service, service to fire marshall, service to 911 staff etc.

The prior art do serve the purpose for keyless entry, it fails to address some other applications such as a device like ETL. Examples of some of the applications are Residential Property for Sale by Owners, Locked Out Service, Lock Status Activity Monitoring for residential/commercial properties, Lock Operation by Fire Marshall, Lock Operation by Law Enforcement Agencies, Lock Operation for Locked Out Automobiles, etc. The present invention is a singular unit that is designed and configured to be coupled to a dead bolt and door knob lock mechanism. When coupled to the door knob lock mechanism (e.g. residential homes, business like) or manufactured as a an integrated unit, the present invention will control the lock mechanism as instructed by the network, keeping in tact its normal use of operation. As shown, none of these previous efforts provide the benefits intended with the present invention as identified by the needs above. Additionally, prior art techniques do not suggest the present inventive combination of component elements as disclosed and claimed herein. The present invention achieves its intended purposes, objectives and components, which is simple to use, with the utilization of a minimum number of functioning parts, at a reasonable cost to manufacture, assemble, test and employing only readily available chipsets and technologies.

### 3 BRIEF DESCRIPTION OF DRAWINGS

FIG. 1 shows main components of End-to-End System Architecture for Network Directed Embedded Transceiver Lock.

FIG. 1A shows High Level Flow Chart of End-to-End System Architecture.

FIG. 1B shows Owner Operated System Architecture Lock Operation (On, Off, Status) by the Owner.

FIG. 2 shows Main Functional components of Embedded Transceiver Lock.

FIG. 3 shows System Architecture for Registration of. Embedded Transceiver Lock

FIG. 4 shows Message flow for Registration using Interactive Call Attendant.

FIG. 5 shows Message flow for Registration using Attendant less (automated).

FIG. 6: Out Band System Architecture for Network Directed Lock Operation (On, Off)— via Network to Home Access Loop

FIG. 6A: System Architecture for Network Directed Transceiver Operation (On, Off) via Network to In Band Caller.

FIG. 7 shows Attendant Less Message Flow for Network Directed Lock Operation (On, Off).

FIG. 8 shows Attendant Directed Message Flow for Network Directed Embedded Transceiver Lock Operation (On, Off).

FIG. 9 shows Message Flow Lock Operation (On, Off, Status) by the Owner.

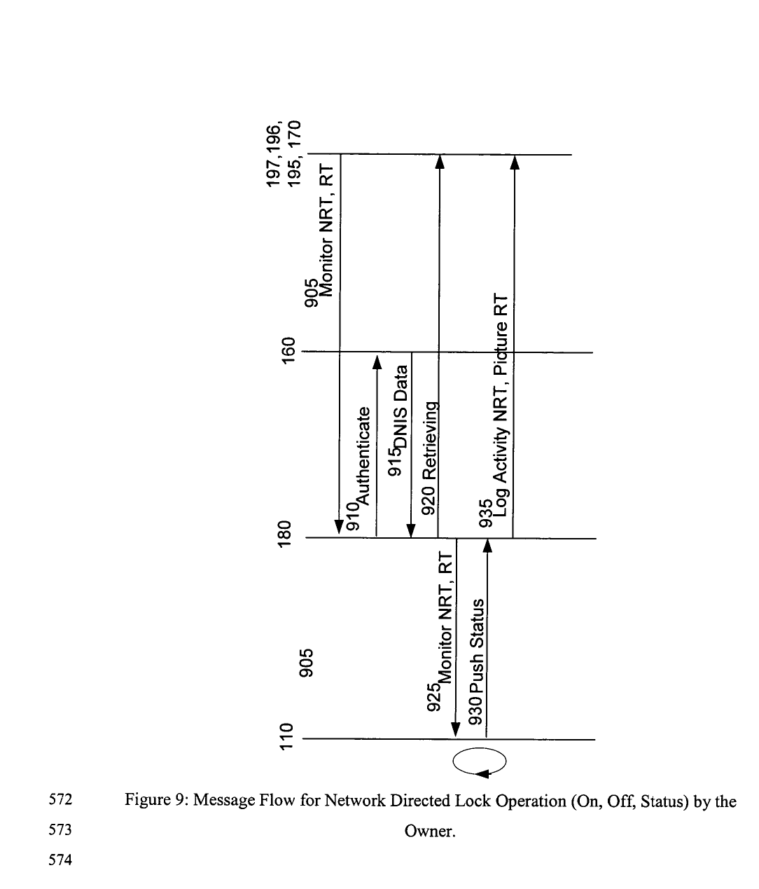

FIG. 10 shows Network Operated System Architecture Lock Monitoring & Message Flow.

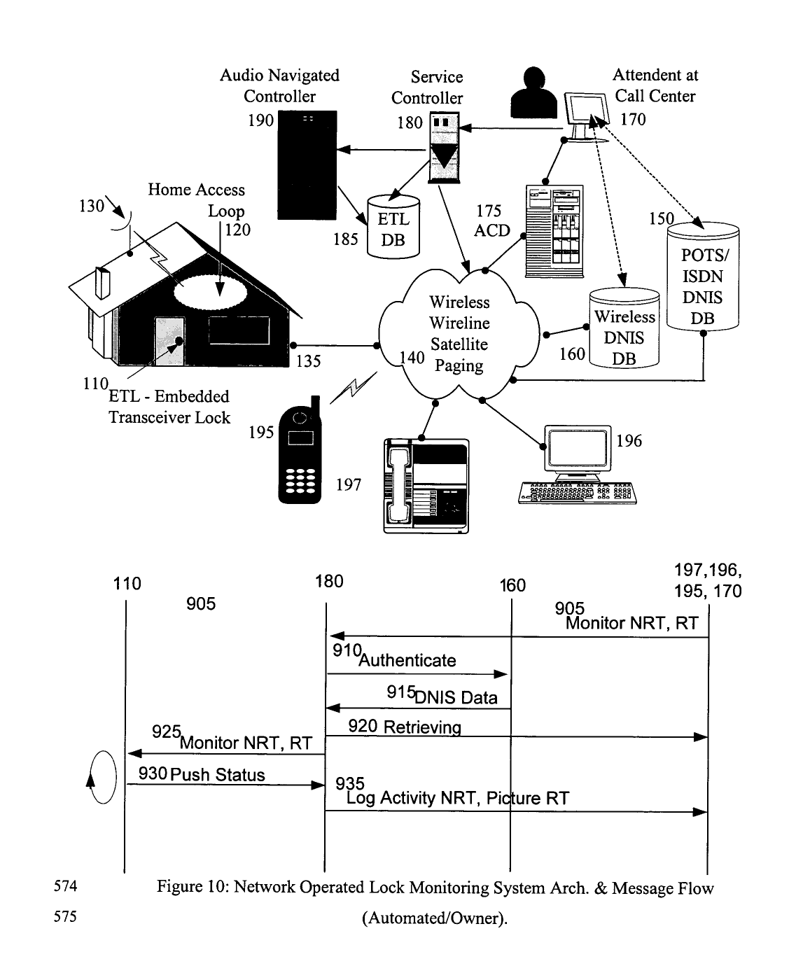

FIG. 11 shows Embedded Transceiver Door Lock over Packet Network.

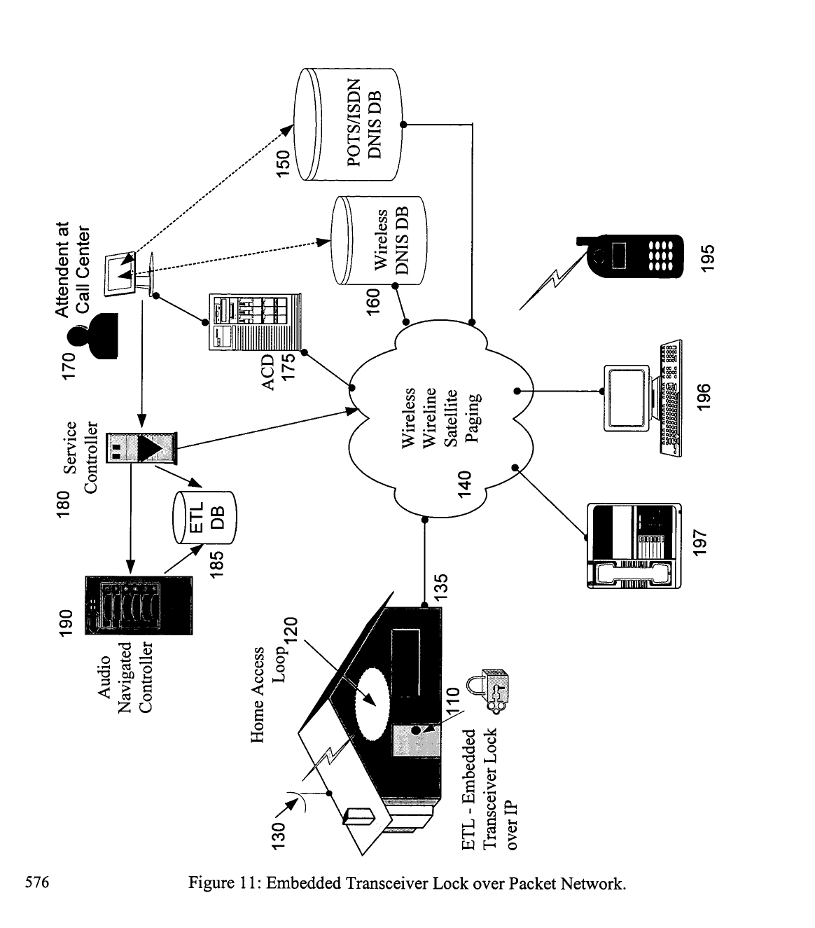

### 4 DESCRIPTION OF THE PREFERRED EMBODIMENTS

While this invention is illustrated and described in a preferred embodiment, the invention may be produced in many different configurations, forms, and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention. Definitions have been provided to help with a general understanding of network transmissions and are not meant to limit their interpretation or use thereof. Thus, one skilled in the art may substitute other known definitions or equivalents without departing from the scope of the present invention.
WAN: Wide Area Network where geographic is limitless with main trade off in being low speed.
LAN: Local Area Network where geographic is limited with main trade off in being in high speed.
Datagram: A packet containing source address, destination address and a payload. Term generally used for in packet networks for unacknowledged delivery of payload. In IP networks, packets are often called datagrams.
Push: Push refers to sending data to a client e.g. ETL device
Pull: Pull refers to requesting data from another device e.g. client.
IWF: Inter Working Function allows communication between two or more dissimilar communicating entities.
Simplex Communication: Refers to transmission in only one where one party is the transmitter and the other party is the receiver. An example of simplex communications is a one way pager (FLEX), wherein users are able to receive data from the network but are unable to transmit data.

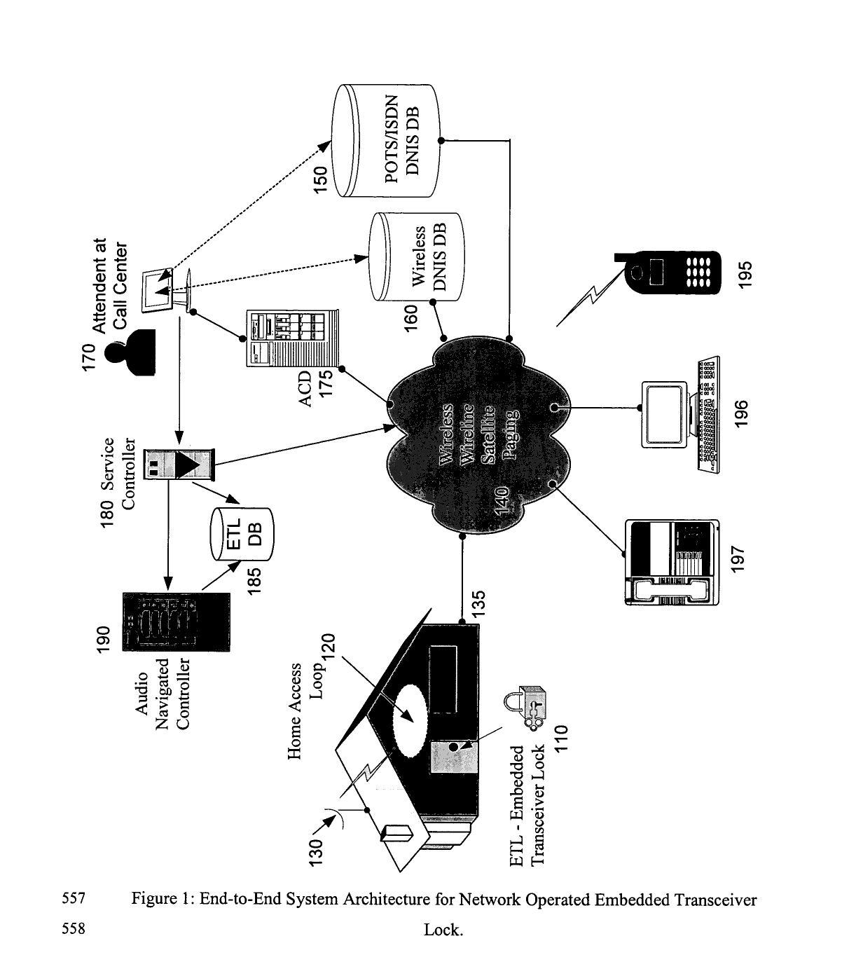

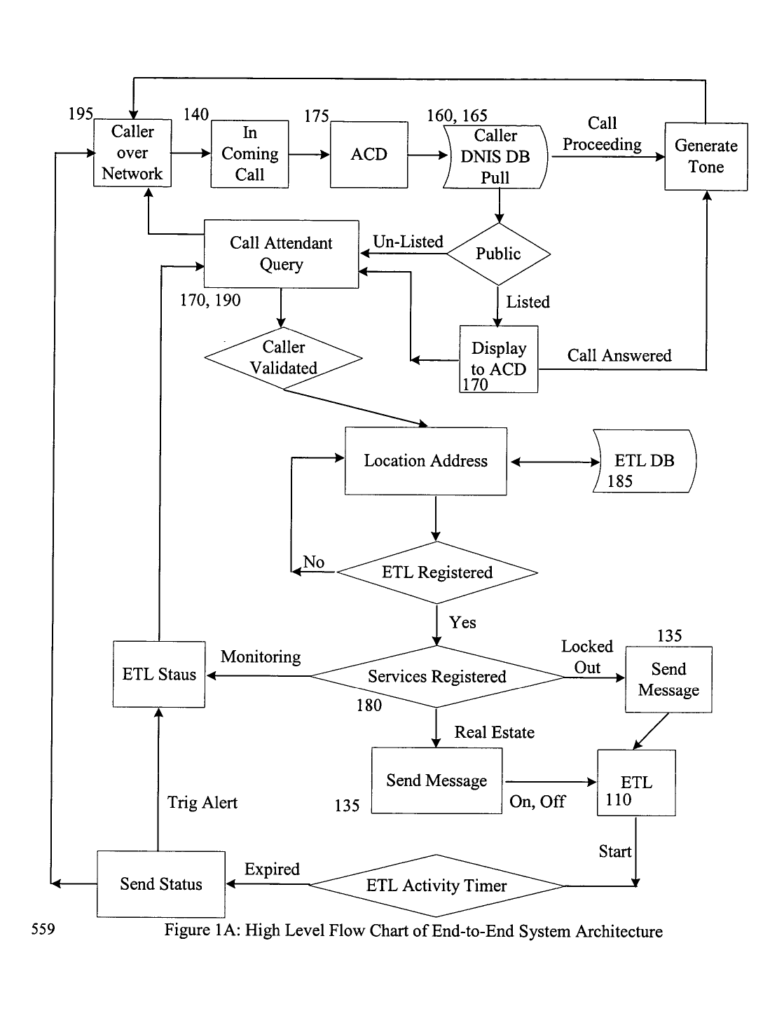

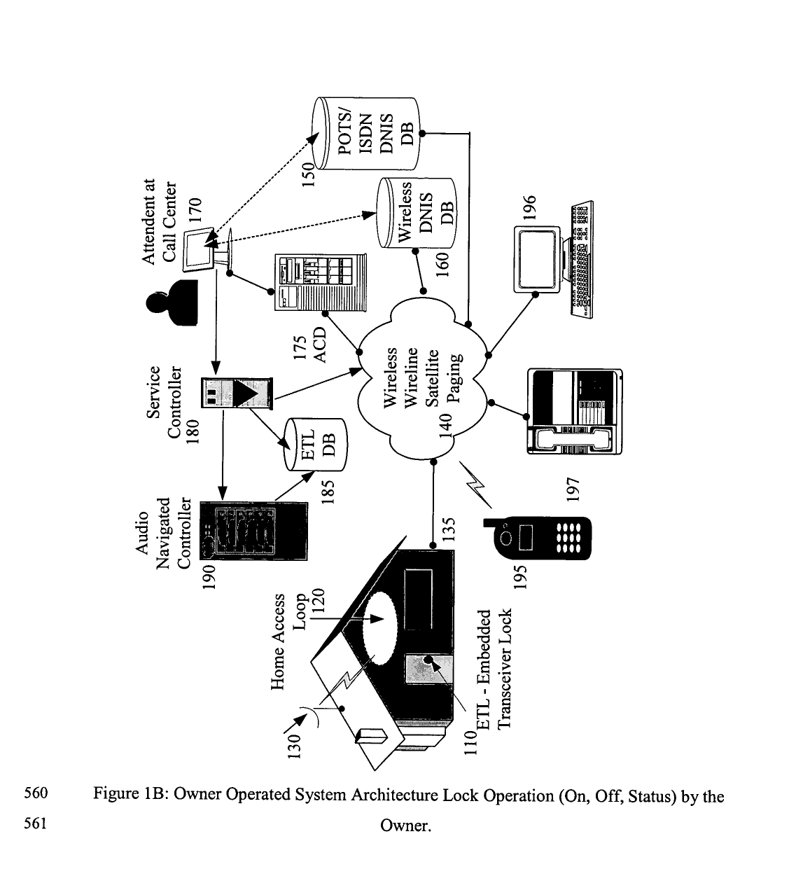

End-to-end system architecture of Network Directed Embedded Transceiver Lock is shown in FIG. 1. Four major components are observed. The embedded transceiver lock 110, the networks access home loop 120, the public/private network 140 equipment and the Door Controller 180. While the home access medium and the corresponding communicating network (whether circuit or packet based) are well known in the art, we discuss these with reference to the ETL 110.

The ETL 110 is first registered with the Service Operator 170 who enters the subscriber information in a repository 185 via service gateway server 180. The registration process s discussed in section 6. Once registered, the ETL is defined as the subscribed ETL and it then obeys as directed by the owner of the ETL or by the Service Operator. Some network directed commands are lock open, lock close and lock status. Few use cases when used as an alternate to the existing door lock mechanism are discussed.

In one use case, a potential buyer wants to inquire about an advertised real-estate property for sale which has an ETL installed. The buyer (or caller) 195 calls the call center via some toll free number. The call gets routed to call center ACD 175 which interacts with the VLR database 60 (or POTS/ISDN database 50 if calling from a landline) and pulls Caller Dialed Number Information (DNIS) such as caller name and address. Once this information is received, the call is terminated to attendant console 170 with caller DNIS data and call answered signal is send to the caller. Upon connect of caller and attendant, the attendant interrogates the caller and verifies its information. Upon validation, the call attendant informs about the property status such as available, showing instructions, under contract etc. If the caller wishes to see the property, the attendant 170 sends a message to door controller 180 to proceed for lock open. The door controller interrogates the 185 about the registered ETL information such as which network interface it is being operated upon. If the ETL has a paging network interface, a coded page message is send. Over paging network and ETL 110 is paged to open. Similarly if POTS (RJ11) interface a coded DTMF signal is send. The coded message is finally terminated to the desired ETL. The tone decoder (217) decodes the message and actuates the lock (210). Once the lock is opened, a video picture (still, motion) can be transmitted real-time or non real-time. Features are added as per need to make the system robust for malicious use.

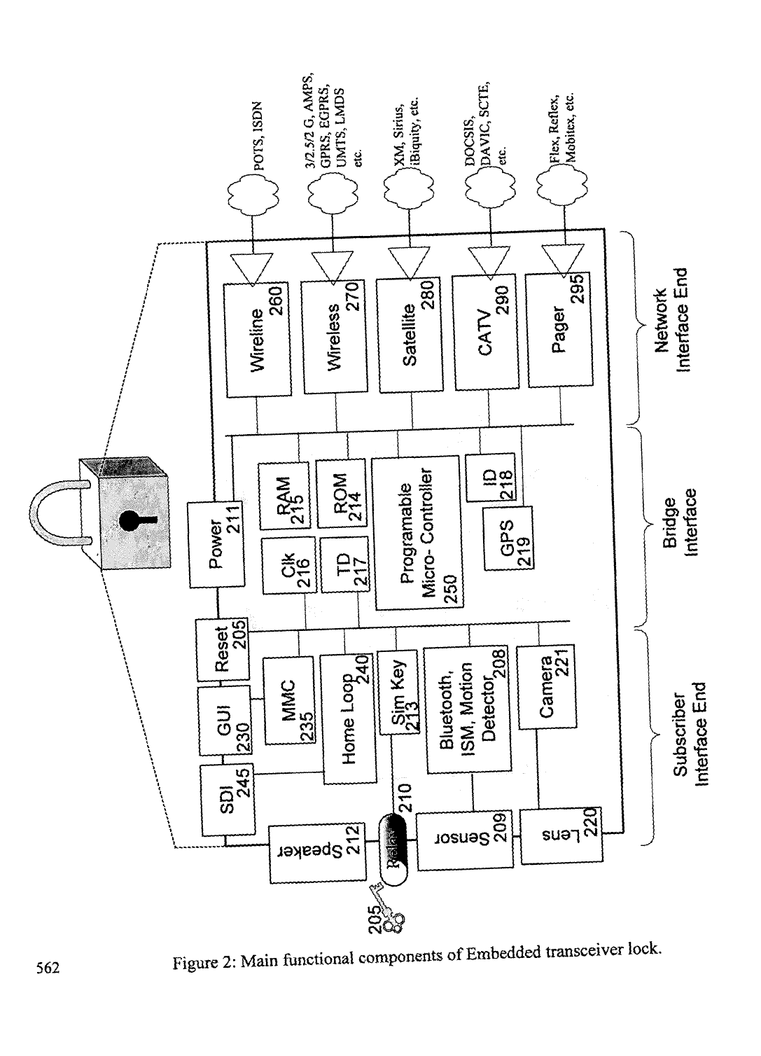

We now discuss the interfaces and functions for ETL 110. The ETL is programmable. Upon request, it can be programmed to a desired Network Loop Access interface and corresponding protocol-signaling stack. As shown in FIG. 2, ETL can functionally be configured in to three major components. These are
Network Interface End: This interface primary communicates with the public/private networks.
Subscriber Interface End: This interface primary communicates with the subscriber external interface.
ETL Bridge Interface: An interworking funcion (IWF) which provides mapping of various protocol stacks and takes intelligent decisions based upon use case.
   4.1 Network Interface End
   4.1.1 POTS, ISDN Interface

The ubiquitous Plain Old Telephone 260 (RJ11) is the proposed default interface of ETL. This is interface is primarily used for registration. The broadband links like (xDSL) is preferred.

4.1.2 Paging Interface

We propose paging interface 295 where minimum services are desired from the ETL. The well-known paging interfaces are REFLEX/FLEX. The ETL device with a paging interface is limited to the data rate transmission of the paging data systems. Once paged the tone detector 217 is used to decode the coded message for example to open the lock. At present, pager like Blueberry/or REFLEX, do allow sending custom data. The ETL therefore can send a proprietary file to the call attendant for proper decodes.

4.1.3 Circuit/Packet Wireless Interface

We propose ETL with data terminal adapter over wireless network access loop 270 as supported by the existing technologies. Various derivatives of these networks are AMPS/DAMPS/TDMA/CDMA/GSM/GPRS/EDGE/UMTS etc. The use of this interface is preferred, especially if single POTS line is in use most of the time at the place of ETL installation.

4.1.4 Broadcast Radio (Terrestrial/Satellite) Interface

We propose ETL with a broadcast digital radio interface 280. Various derivatives of such networks are XM™, SiriUS™, iBiquity™ or other as they emerge from time-to-time. The use of broadcast digital radio interface in ETL is very meaning full for sending a single message like “Open Lock” for bulk open e.g. most likely commercial properties in Strip Malls etc.

4.1.5 Home Loop

An up-link (ETL to network) is established via home loop mechanism 240. Instead of running wires from ETL to outside access loop, prior art exists which allow making use of power jacks as telephony loop. Similarly, one can have wireless LAN as a means of communication with external entities.

4.1.6 HFC/LMDS Interface

For some places, HFC/LMDS 290 may be used as a network access loop interface. Therefore, it is proposed that ETL should be able to communicate with broadband HFC guerillas. The broadband may allow interactive video activity when instructed by the network.

4.2 SubscriberInterface End

4.2.1 Man Machine Interface

ETL need some man machine interface 235 for educating the subscriber about its current state of activity. Some proposed GUI 230 interfaces are as follows:
Light emitting Diodes with Green, Red, Amber
Operation on LEDs: On/Off/Blink fast/Blink Slow
LCD: visual aid mechanisms to inform using alphanumeric display e.g. 48 or more character display.
   4.2.2 Subscriber Data Interface—SDI

A SDI 245 mechanism to allow to the owner of ETL to download the ETL activity data to an external communicating devices like local PC, PDA etc by using home access loop mechanism such as Bluetooth, USB, Infrared, RS-232, or Ethernet (wired/wireless) or some other proprietary serial link interface.

4.2.3 Video Interface

A mechanism (lens 220, camera digitizer 221) to take picture at the time of entry, or at the time of exit or both. The trigger mechanism of camera 210 is a signal received from external motion sensor 209 or as instructed by the network. A suggested place for this camera is eyehole in the door.

4.2.4 External Reset Button

A mechanism 205 to reset, the ETL to its unregistered state. Can also perform soft reset by the network.

4.2.5 Power

ETL need external power 211 for its operation. It also need battery as a backup mechanism.

4.3 ETL Bridge Interface

Programmable micro controller 250 can be programmed to any home loop and network access loop signaling stack. The controller 250 monitors activity as it occurs either on the subscriber interface or on the network interface. Based upon the activity decisions as stored in 214 are taken. The processing of the information may need scratch space, which is provided by 215. It is important to time tag the ETL activity. For this purpose a regular clock 216 or GPS synched 219 be provided. The ETL has its own unique 32 bit number identification 218 and is used for registration with the service operator. A Sim Key 213 is a special passive key, which is when inserted in ETL over rides the network rules.

5 System Functional Components

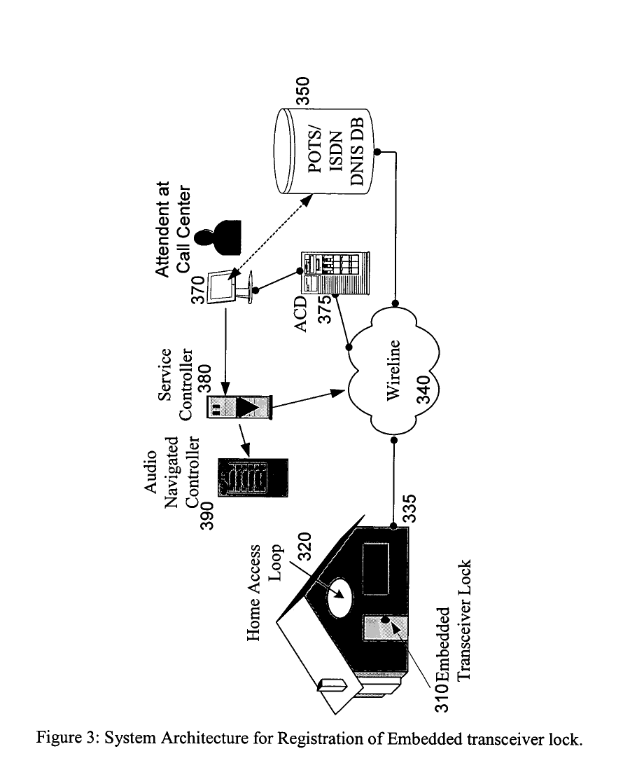

The service operator may lease the ETL device or it can be purchased from the retail stores. In any case, the ETL need to be first registered with the service operator. The service operator may be different for each service. Refer to “Use cases” in section 7. FIG. 3 refers to system architecture applicable to ETL registration. When ETL 310 is hooked up with 335 and is powered, the ROM boot software kicks in and initiates a registration process with the service operator 370. The service operator pulls caller info from 350 via some ACD 375 mechanism. Upon confirmation of caller self spoken DNIS and retrieved DNIS, registration process is initiated.

5.1 Registration

In the registration process the service operator interrogates the following information:
1. ETL ID 218. The 32 bit ID is structured to provide unique ETL MAC address along with other information such as: Manufacture id, product access loop type (wired/wireless/others, simplex/duplex), GUI size, RAM/ROM size etc.
2. RBOC Ten Digit Telephone Number of the place where ETL is to be used.
3. Postal Address of place.
4. Owner selected some secure ID (alphanumeric characters) for data retrieval and information change.
   5.1.1 Pre Registered

The service operator may pre-program the ETL as per subscriber need and ship it to the subscriber. This method is pre-registered. While this form of registration can be used for all types ETL with simplex or duplex interface, it is the only method for ETL which are simplex (e.g. one way pager 295). Once registered, the system performs on/off operation of the lock. ETL with duplex link, provide various ways of getting the above information via attendant or automatic. These are discussed as follows.

5.1.2 Via Networked Attendant

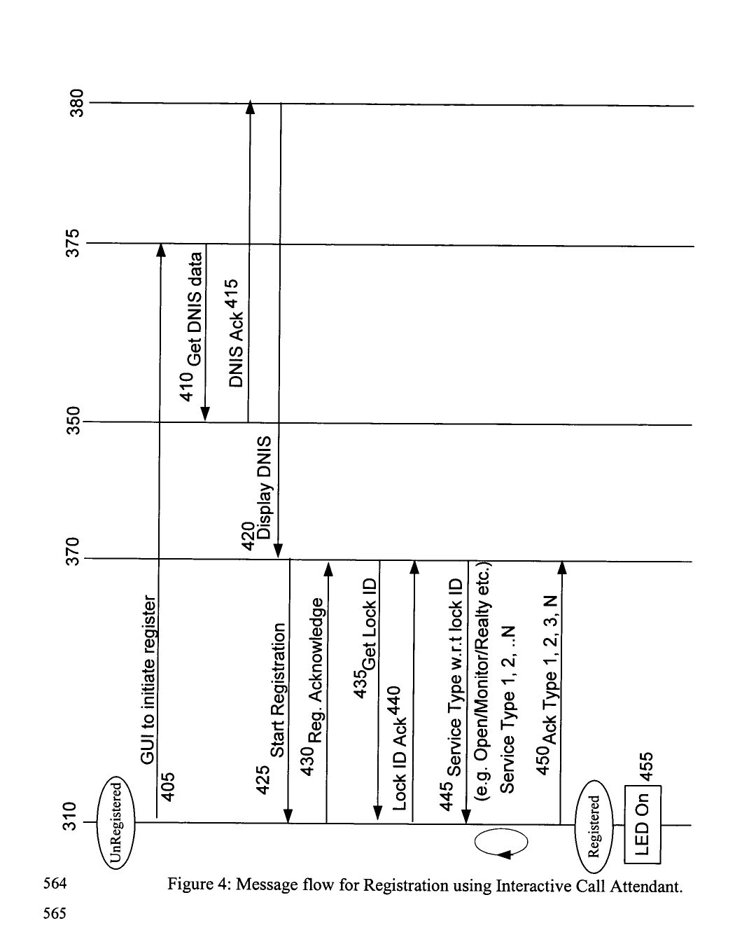

FIG. 4 describe message flow used for registering ETL via some call center attendant. The subscriber power up the ETL hooks it with 295 and let the ETL boot software kicks in. An out bound call 405 is initiated from ETL 310 and terminates on ACD 375 which pulls caller DNIS data info 410 from 350 and ack with DNIS data 415 to door controller serer 380 with visual data 420 to call attendant console 470 where an attendant services the subscriber. Interactive dialogue for registration attributes (as said in the above section 6.1) is exchanged between the subscriber and the attendant refer Start Registration 425, Registration Ack 430, Get Lock ID 435, Lock ID Ack 440, Service Presents Open/monitor/Realty 445, Select Service Ack 450. The subscriber may request for various levels of services from service provider as discussed in section 7 of this invention. Upon completion of this, the attendant performs remote test operation on the ETL 455. These are discussed in section 6.1.4. The ETL is ready for use.

5.1.3 Attendant Less

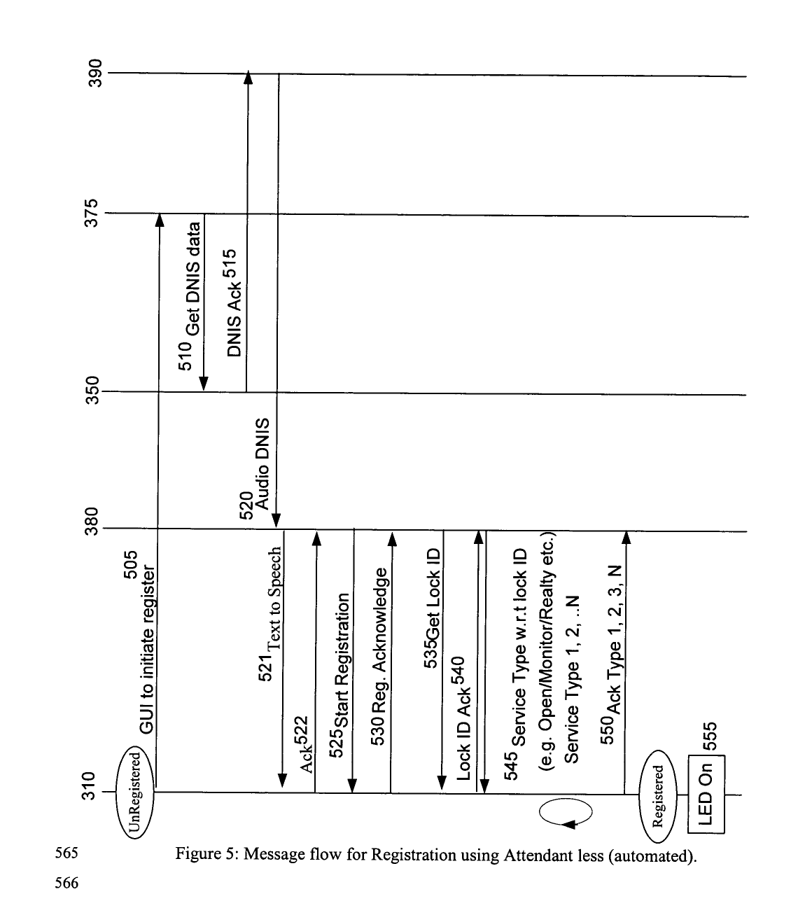

FIG. 5 describe message flow via attendant less i.e. audio navigated call attendant. The subscriber power up the ETL hooks it with 295 and let the ETL boot software kicks in. An out bound call 505 is initiated from ETL and terminates on ACD 375 which pulls caller DNIS data info 510 from 350 ack with DNIS data 515 to door controller serer 380 with audio data play back 520 to the calling party (505). Upon listening 521 the subscriber must verify this data. Upon verification by the subscriber, the system 580 starts the registration process. Start Registration 525, Registration Ack 530, Get Lock ID 535, Lock ID Ack 540, Service Presents Open/monitor/Realty 545, Select Service Ack 550. The subscriber may request for various levels of services from service provider as discussed in section 7 of this invention. Upon completion of this, the attendant performs remote test operation on the ETL 555. These are discussed in section 6.1.4. The ETL is ready for use. 5.1.4 ETL Installation & Test The self-install kit is provided for ETL installation. At the out set, the existing door lock (preferably the main entrance) is replaced with the ETL assembly. The embedded lock is hooked up with one of the access network interface. Upon power up, the 235 module kicks in to determine Registration State and displays the ETL system status by LED. In parallel, the boot software performs registration as stated earlier. Following is the output of registration process.
1. Fail if the use of ETL is at a place other than it is subscriber for.
2. Passes if it is installed at the correct POP address (i.e. verified through POP telephone directory).
3. A Lock on/off test operation is performed by the remote and green indicator is set, indicating proper installation.
4. If lock is not properly installed, red led is turned on, indicating an alarm condition. Network is alerted for remedial.
5. Various visual LED 230 interfaces may be used for following:
   LED Green on: A visual aid mechanism to inform ETL self check System OK, and active.
   LED Green Slow Blink: ETL system registered.
   LED Red On: A visual aid mechanism to inform Not Registered
   LED Red Blink On: A visual aid mechanism to inform Registration in process (not applicable for simplex).
   LED Off: A visual aid mechanism to inform No Power, Inactive, and Unregistered.
   LCD: Alphanumeric display (e.g. 48 or more characters) of current activity as performed.
      5.1.5 Fail Safe Operation

A fail-safe intelligence is added in the ETL, which triggers re-register every time the ETL is powered off (or power lost). This mechanism prevents use of ETL at unauthorized places.

5.2 Operation Mode

The ETL is designed to operate in the following modes:

5.2.1 Keyed Entry

This mode of operation is meant for the person holding special ETL mechanical key. A special key with passive inductance is supplied with the ETL. The owner of the ETL will generally desire a keyed entry. If any other key is inserted and relay 210 is actuated—an alarm condition is noted and network is alerted (feature not applicable for simplex).

5.2.2 Network Polled Entry

Refer section 7 for possible use case where it is desired to perform an operation on the ETL. The network can poll the ETL for following operations:
1. On—ETL e.g. for Lock Open.
2. Off—ETL e.g. for Lock Close.
3. Status—ETL used to gather statistics.
   5.2.3 Polled to Network

The ETL has a monitoring software module. Any time the ETL is operated, it stores the time for which it remained opened; it stores the picture of the visitor (if interfaced). If the door remained open for a certain threshold of time, the call center is alerted and an auto call is triggered to the visitor on his cell phone to close the door (or to the owner of the property that the subject is unlocked). Auto alert feature not applicable to simplex.

5.2.4 ETL Data Retrieval

The data stored by the ETL can be used by the call center for statistical purpose as well as to provide additional services to the owner ETL. Such as who called, time stayed as well identity picture(s) of the visited party. The ETL stored visitor data can be retrieved as follows:

5.2.4.1 Local Retrieval

In local retrieval mode, subscriber external device like PC/PDA communicates with subscriber data interface SDI 245 (e.g. RS-232, USB, etc.) and data is downloaded/synched from ETL to PC/PDA.

5.2.4.2 Network Polled Retrieval

In network retrieval mode, a special software agent in the PC/PDA, polls the controller 180 for his ETL status update. The client server architecture may be used for this type of activity. Any record associated with the registered ETL is downloaded to the subscriber-communicating device.

5.2.4.3 Network Update to Subscriber

In this type of operation, the controller 180 monitors the activity bits of the registered ETL. During off peak hours e.g. at night, it sends an e-mail alert to the subscriber that a change is noted with his registered ETL. The subscriber may later log on to 180 to get the change as noted.

6 Use Cases

The proposed device (ETL) use case may be unlimited e.g. Lock Operation by Fire Marshall, Lock Operation by Law Enforcement Agencies, Lock Operation for Locked Out Automobiles, Offices/Strip Malls Bulk Open/Close etc. However, we discuss the use cases when used as an alternative to the door locks for followings:
Real Estate for Sale by Owners.
Locked Out Service.
Monitoring Service.

We discuss above functionally.

6.1 Real Estate for Sale by HomeOwner

One use of ETL is for homeowners who want to sell their property. They can do that by either working with a real estate broker for which they have commit some portion of the commission sale proceed (which may be high) or they can sell of their own if they want to save the commission. If they are interested in selling of their own, then the owner may need to be present at home to open the door when a potential buyer want to visit and see the property. This may not very practical always. One solution is, he can place the key in a combination lock box. This brings another set of issues e.g. the owner has to interrogate about the visitor identity before the combination is released. This implies that he may need to change the lock box combination frequently etc. For a situation like these, network operated ETL operation is a solution.

To make use of ETL, the homeowner needs to replace the existing door lock (preferably the main entrance lock) with the ETL. Various lock derivatives are discussed in section 5.1 & 5.2 (refer FIG. 2) of this invention. The homeowner may pick one or other of these as per his service need and cost budget. We now discuss network operation on the ETL for Sale by Owner (FSBO) use case.

6.1.1 Remote Lock Operation

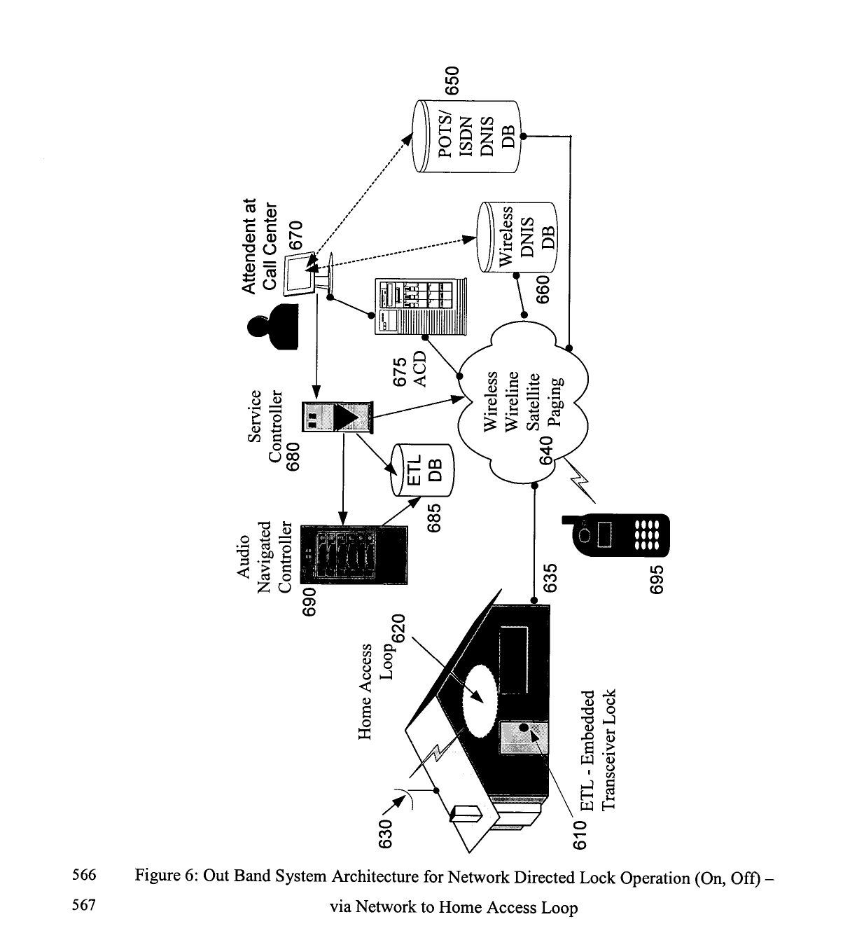

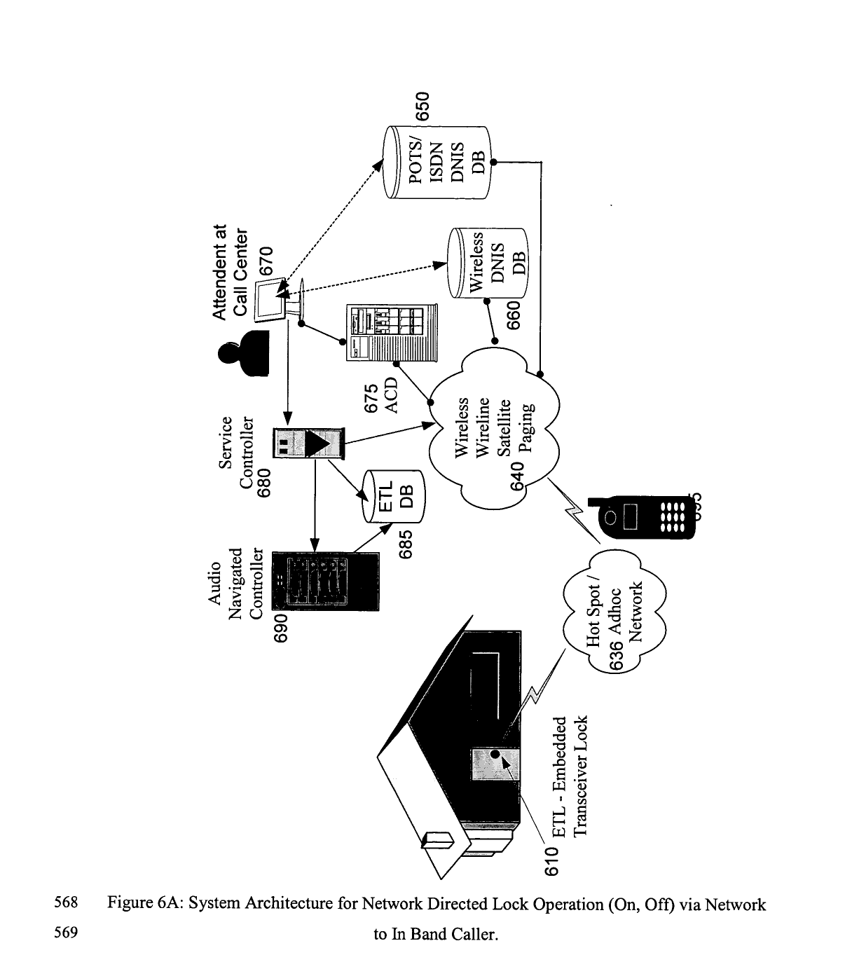

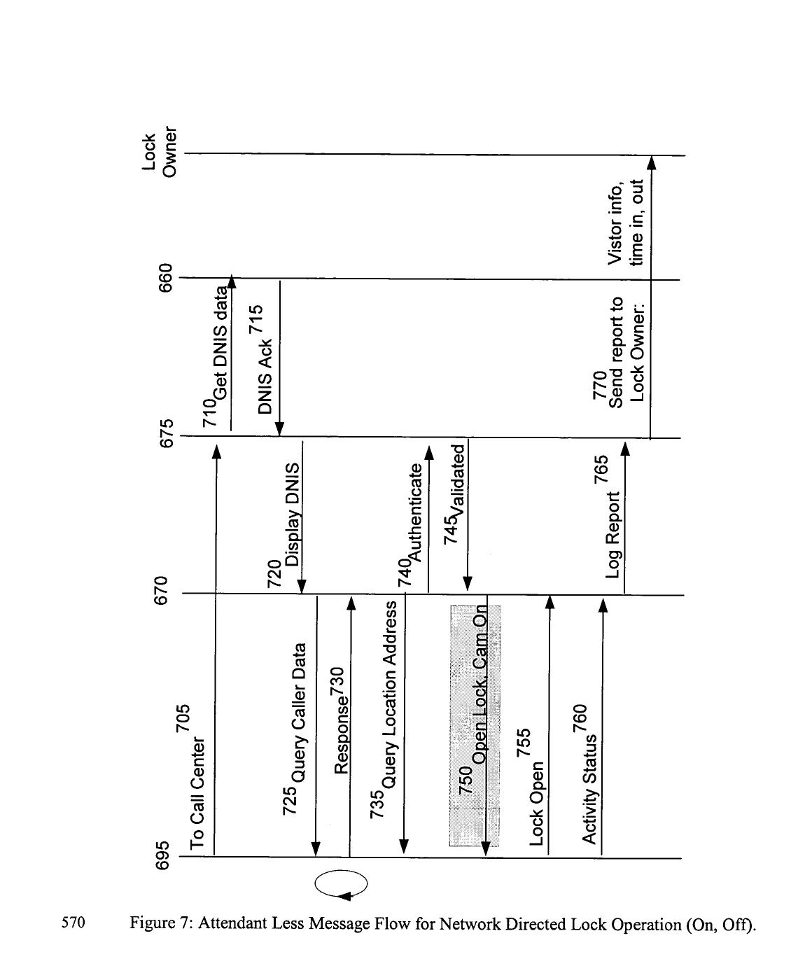

Refer FIG. 6, for System Architecture for use case for FSBO with Attendant, FIG. 7 is the corresponding message flow. In order for the lock to work it must be first registered with a service provider. The registration process is discussed in section 6.1. When the caller 695 (i.e. the buyer) calls FSBO advertised number 705, the call is terminated the remote service call center 675, which polls VLR 660 for caller DNIS info 710. Upon caller data retrieval 710, the ACD 660 presents visual data to attendant 670 and sends a call connect message to caller 695. Upon connect (caller 695 & attendant 670), the attendant validates the caller data by queries name, info, address as show in message flow in 725, 730, 735, 740, 745. Answers to these questions must match with DNIS data. Based upon answers, caller may be authenticated. The door controller 680 is an intelligent device in the sense, that it stores the caller data so that for next calls it does not poll the 660 for DNIS info 710. This information may be kept in the system for few months based upon the last called trigger. After validation, the attendant verifies property status (available, under attorney review, under contract, on hold till further showing, or off the market) to the caller 795. If available, the prior registration of the embedded systems indicates what is the type of the lock and associated loop access interface. The lock controller server 780, sends inbound signaling message 750 based upon the type of embedded lock to turn OFF—ETL (i.e. open lock).
If simplex sends a coded page message, this triggers the DTMF, which triggers the Lock to OFF position.
If duplex sends a DTMF message, which triggers the Lock to off position.

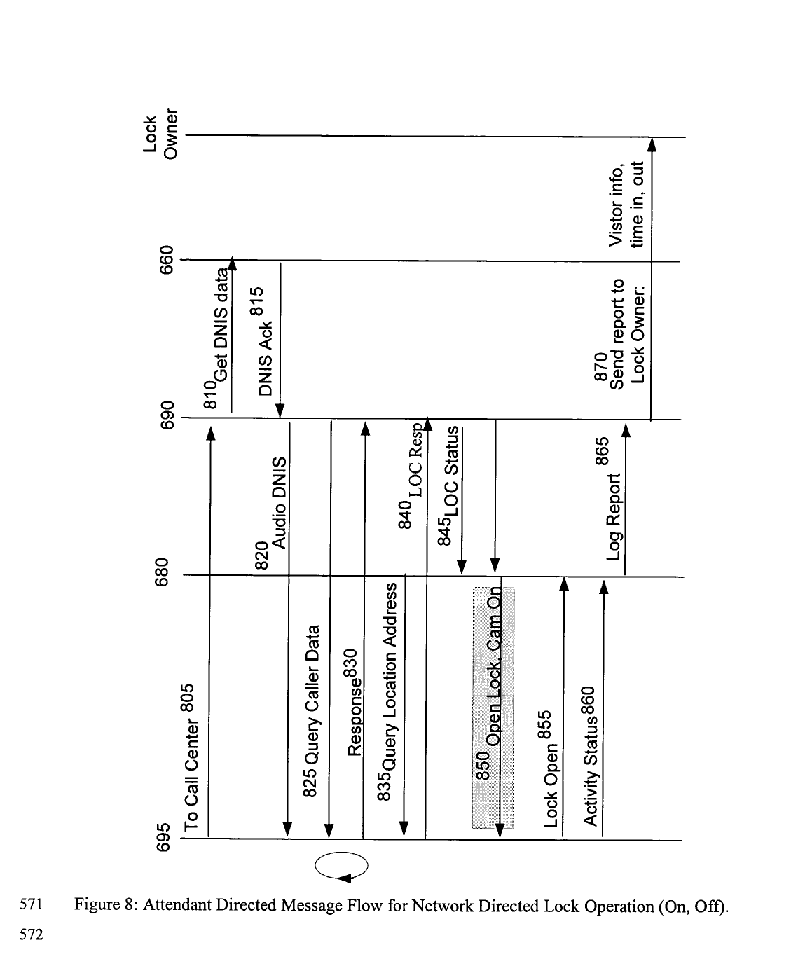

Another format of verification is that, the call center controller is interfaced with some play back audio device as shown in FIG. 6. Once the DNIS data is fed to the audio device 690, the audio device plays back the DNIS information to the caller 695. After the text-to-speech of DNIS is completed, 680/or 685 query the caller to confirm or deny (825, 830). If denied, 680 divert the call to the attendant for further interrogation. If accepted, the software checks status (available, under attorney review, under contract, on hold till further showing, or expire or of the market 840, 845), call is logged for record and an authenticated message is send to the server for remote lock operation. The message flow of these interactions is shown in FIG. 8.

The other function of the service gateway server 680 is to generate a short report and e-mail to the owner of the ETL number of visitors, their name and address, pictures (if taken) and how long they stayed in the house. It can be fairly assumed that the interested visitor will contact of his own for further information e.g. negotiating offer, putting up sale contract, attorney review, inspections, appraisal, final walk through before closing and closing. The invention of ETL therefore facilitates door open/close for inspectors, and appraisers.

In another variant the service operator, pre downloads property status like (available, sold, under contract et.). A consumer device like 695 with a bluetooth interface. An adhoc or hot spot network is established between 695 and ETL 610 using well-known art in the literature. The information exchanged is exchanged is status. If available, ETL ID 218 is exchanged and device 695, sends an uplink packet to the service operator. As stated above, a verification process is initiated, upon validation, the seervice operator sends a message to the ETL to open the lock.

In another variant a hot spot or adhoc net is established between device 695 and ETL 610 to determine ETL ID 218. Application running in device 695, sends a message to call center about status inquiry and property listing view request. If available, and caller data verified as said above, an inbound message is send to ETL 60 via 695 over bluetooth or ISM to open the lock.

6.2 Agent Less Property Showing

In this use case, the ETL is placed by a listing agent at the desired property for sale. At present, an real-estate sales agent has to accompany the buyer to open the lock. Using the ETL system such visit can be eliminated. In order for the lock to work it must be first registered with a service provider in this case Real Estate Broker. The registration process is discussed in section 6.1. When the caller 695 (i.e. the buyer) calls the broker advertised number 705, the call is terminated the remote service call center 675, which polls VLR 660 for caller DNIS info 710. Various variants of 675 are distributed Broker Offices which individually connects to 660 or a centralized broker as shown in FIG. 6. Upon caller data retrieval 710, the ACD 660 presents visual data to attendant 670 and sends a call connect message to caller 695. Upon connect (caller 695 & attendant 670), the attendant validates the caller data by queries name, info, address as show in message flow in 725, 730, 735, 740, 745. Answers to these questions must match with DNIS data. Based upon answers, caller may be authenticated. The door controller 680 is an intelligent device in the sense, that it stores the caller data so that for next calls it does not poll the 660 for DNIS info 710. This information may be kept in the system for few months based upon the last called trigger.

After validation, the attendant verifies property status (available, under attorney review, under contract, on hold till further showing, or off the market) to the caller 795. If available, the prior registration of the embedded systems indicates what is the type of the lock and associated loop access interface. The lock controller server 780, sends inbound signaling message 750 based upon the type of embedded lock to turn OFF—ETL (i.e. open lock).
If simplex sends a coded page message, this triggers the DTMF, which triggers the Lock to OFF position.
If duplex sends a DTMF message, which triggers the Lock to off position.

Another format of verification is that, the call center controller is interfaced with some play back audio device as shown in FIG. 6. Once the DNIS data is fed to the audio device 690, the audio device plays back the DNIS information to the caller 695. After the text-to-speech of DNIS is completed, 680/or 685 query the caller to confirm or deny (825, 830). If denied, 680 divert the call to the attendant for further interrogation. If accepted, the software checks status (available, under attorney review, under contract, on hold till further showing, or expire or of the market 840, 845), call is logged for record and an authenticated message is send to the server for remote lock operation. The message flow of these interactions is shown in FIG. 8.

The other function of the service gateway server 680 is to generate a short report and e-mail to the owner of the ETL number of visitors, their name and address, pictures (if taken) and how long they stayed in the house. It can be fairly assumed that the interested visitor will contact of his own for further information e.g. negotiating offer, putting up sale contract, attorney review, inspections, appraisal, final walk through before closing and closing. The invention of ETL therefore facilitates door open/close for inspectors, and appraisers.

In another variant the service operator, pre downloads property status like (available, sold, under contract et.). A consumer device like 695 with a bluetooth interface. An adhoc or hot spot network is established between 695 and ETL 610 using well-known art in the literature. The information exchanged is exchanged is status. If available, ETL ID 218 is exchanged and device 695, sends an uplink packet to the service operator. As stated above, a verification process is initiated, upon validation, the service operator sends a message to the ETL to open the lock.

In another variant a hot spot or adhoc net is established between device 695 and ETL 610 to determine ETL ID 218. Application running in device 695, sends a message to call center about status inquiry and property listing view request. If available, and caller data verified as said above, an inbound message is send to ETL 60 via 695 over bluetooth or ISM to open the lock.

6.3 Locked Out Service

As the service name applies, the owner of ETL is locked out. When the owner calls the service operator, service operator inquires about his wire line telephone number, pulls up the DNIS information and ask for a private key under which his ETL was registered (refer to section 6.1). Upon confirmation, the network call attendant sends a message to the service gateway server for door open operation. From the information, the door controller determines the terminating ETL access loop interface. It therefore sends a signaling message to ETL to open the door. As stated earlier, the same can be done via automated call attendant using text-to-speech. The functional message interaction has been functionally discussed in the previous sections.

6.4 Monitoring Service

For residential or commercial properties a monitoring service may be desired. This service is applicable to ETL with duplex interface. Once activated by the service operator, the ETL keep track of the status activity. The ETL alerts the network call attendant if an abnormal activity is observed e.g. intrusion with an unauthorized passive key, picture camera-monitoring etc.

For commercial property e.g. Strip Malls, it may be desired to open lock at morning business and similarly close lock when business is over. The door controller, make use of existing digital broadcast networks (XM™, Sirius™, iBiquity™ or other as they emerge from time-to-time), sends a broadcast message to ETL to open the lock. Similarly when strip malls are closed, sends a message to lock. This method is efficient compared to individual polls.

1. An Embedded Transceiver Lock for receiving and transmitting data content, said data content from and to a remote service gateway via a network call attendant, said embedded transceiver lock comprising:
(a) A subscriber network interface simplex/duplex for communication with the service gateway.
(b) A subscriber man machine serial interface to communicate with the consumer electronics.
(c) A Man Machine interface like LEDS, LCDs with alphanumeric capability.
(d) Additional module like Motion Detector, Digital Camera, GPS module, Clock and Bluetooth for enhance services.
(e) A unique 32 bit transceiver MAC-ID with structure to provide manufacturer ID.
(f) A method to register with the desired service gateway for service(s) initialization and a dynamic IP address allocation.
(g) A receiving unit, receiving data content, said data content via service gateway over public/private network . . . Continue to line 474 to 556
